(19) United States
(12) Patent Application Publication
(10) Pub. No.: US 2025/0131251 A1
(43) Pub. Date: Apr. 24, 2025

(54) ROUTING TO EXPERT SUBNETWORKS IN MIXTURE-OF-EXPERTS NEURAL NETWORKS

(71) Applicant: Google LLC, Mountain View, CA (US)

(72) Inventors: Hanxiao Liu, Santa Clara, CA (US); Quoc V. Le, Sunnyvale, CA (US); Yanqi Zhou, Sunnyvale, CA (US); Tao Lei, Sunnyvale, CA (US); Yuzhe Zhao, San Francisco, CA (US); Yanping Huang, Mountain View, CA (US); Nan Du, San Jose, CA (US); Zhifeng Chen, Sunnyvale, CA (US); Andrew M. Dai, San Francisco, CA (US); James Laudon, Madison, WI (US)

(21) Appl. No.: 18/834,070

(22) PCT Filed: Jan. 30, 2023
(86) PCT No.: PCT/US2023/011901

§ 371 Date: Jul. 29, 2024

Related U.S. Application Data
(60) Provisional application No. 63/304,507, filed on Jan. 28, 2022.

(51) Int. Cl. G06N 3/048

(52) U.S. Cl. CPC G06N 3/048

(57) ABSTRACT

Methods, systems, and apparatus, including computer programs encoded on a computer storage medium, for performing a machine learning task on a network input to generate a network output. In one aspect, one of the systems includes a neural network configured to perform the machine learning task, the neural network including one or more expert neural network blocks that each include router that performs expert-choice routing between multiple expert neural networks.

### CROSS-REFERENCE TO RELATED APPLICATIONS

This application claims the benefit of priority to U.S. Provisional Application Ser. No. 63/304,507, filed Jan. 28, 2022, the entirety of which is incorporated herein by reference.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that is configured to process a network input using a neural network and to generate a network output characterizing the network input. The neural network includes a sequence of one or more network blocks that are each configured to process a block input that includes the network input or an intermediate representation of the network input and to generate a block output.

For example, the first network block in the sequence of network blocks can process the network input to generate a block output that is an intermediate representation of the network input. As another example, an embedding subnetwork can process the network input to generate embeddings of the network input that are provided as input to the first network block in the sequence, which processes the embeddings to generate an intermediate representation of the network input. Each subsequent network block can then process the block output of the previous network block in the sequence. In some implementations, the network output for the neural network is the block output of the final network block in the sequence. In some other implementations, the block output of the final network block in the sequence is further processed using one or more output neural network layers to generate the network output for the neural network.

The sequence of network blocks can include one or more “expert” network blocks. Each expert network block includes multiple different expert subnetworks that are each configured to process respective sub-inputs determined from the block input to the expert network block. Each sub-input of the block input includes a respective different subset of the elements of the block input.

Unlike conventional approaches, the expert network blocks route sub-inputs to expert subnetworks using “subnetwork-choice” or “expert-choice” routing, i.e., where the neural network block independently selects, for each expert subnetwork, a set of elements of the block input to be processed by the expert subnetwork.

Particular embodiments of the subject matter described in this specification can be implemented so as to realize one or more of the following advantages.

By implementing neural networks with network blocks that include multiple expert subnetworks each configured to process a subset of the input to the network block, a system can increase the capacity of the neural network without increasing the computational resources required to execute the neural network at inference time. That is, by selectively activating only a subset of the parameters of the neural network for each element of a network input, the system can significantly improve the time and computational efficiency of the neural network relative to other neural network with the same number of parameters. Introducing this sparsity can allow the neural network to include many more network parameters than was previously feasible, since only a subset of the parameters are used to process any given input.

Some existing systems that implement neural network blocks with multiple expert subnetworks use “token-choice” routing, i.e., where the neural network block independently selects, for each element of the block input, a set of expert subnetworks to process the element. However, these existing systems can suffer from load imbalance, where some expert subnetworks process most or all of the elements of the block input while other expert subnetworks process very few or none of the elements of the block input. Such load imbalance can result in sub-optimal training because a portion of the network parameters (corresponding to the under-utilized expert subnetworks) do not receive meaningful updates during training and thus do not learn to extract useful information. Furthermore, exiting systems that use token-choice routing dedicate the same amount of computational resources to each element of the network input, disregarding the relative importance of different elements, which can further reduce the computational efficiency of the systems.

Using techniques described in this specification, a system can implement neural network blocks with multiple expert subnetworks using “subnetwork-choice” or “expert-choice” routing, i.e., where the neural network block independently selects, for each expert subnetwork, a set of elements of the block input to be processed by the expert subnetwork. Subnetwork-choice routing can ensure that the network block is perfectly load balanced, e.g., by selecting the same number k of elements to be processed by each expert subnetwork. The computational and time efficiency of training the neural network can thus be significantly improved, as all parameters of the neural network receive meaningful updates for each network input. In some implementations, a neural network training system can reduce the time and computational resources required to achieve a predetermined performance using subnetwork-choice routing by more than 2× compared to token-choice routing. Furthermore, subnetwork-choice routing can allow a network block to more flexibly allocate computational resources to respective elements, e.g., by routing relatively important elements to more expert subnetworks than relatively unimportant elements.

In particular, in some implementations in which a system executes different expert subnetworks on respective different devices, the techniques described in this specification allow the system to load balance network inputs to the neural network more efficiently across devices relative to existing techniques (e.g., relative to systems that implement token-choice routing). The inferior load balancing that the existing systems suffer because of the token-choice routing can harm inference performance (e.g., by reducing computational and/or memory efficiency or by increasing the amount of time required to generate a network output) because different devices executing different expert subnetworks can have significantly different loads, and thus some devices can be underutilized while others can be overworked. Using subnetwork-choice routing as described in this specification, perfect load balancing can be “baked in” at inference time, the system can enjoy significantly improved performance (e.g., increased computational and/or memory efficiency or decreased time required to generate a network output) across the multiple devices because the multiple devices each have a similar or equivalent amount of operations to execute. Therefore, relative to other existing approaches, the described approach results in a system that can process inputs at a higher throughput relative to conventional approaches by being optimized for a distributed hardware implementation.

In some implementations described in this specification, each expert subnetwork can be configured through training to process different types of network inputs, allowing the expert subnetworks to “specialize” and further improving the efficiency and performance of the neural network. Using “subnetwork-choice” routing can further improve the specialization of the expert subnetworks relative to “token-choice” routing because the respective routing subnetwork corresponding to each expert subnetwork can learn through training to select elements of a particular type to be processed by the expert subnetwork.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows the operation of an expert block that uses expert-choice routing relative to token-choice routing.

FIG. 3 is a flow diagram of an example process for processing a network input to generate a network output.

Like reference numbers and designations in the various drawings indicate like elements.

### DETAILED DESCRIPTION

This specification describes a system implemented as computer programs on one or more computers in one or more locations that performs a machine learning task on a network input to generate a network output for the machine learning task.

The machine learning task can be any machine learning task that operates on a network input that is an input sequence, i.e., a collection of multiple elements, to generate a network output for the network input.

Some examples of machine learning tasks that the system can be configured to perform follow.

As another example, the task may be an audio processing task. For example, if the input to the neural network is a sequence representing a spoken utterance, the output can be a classification output that classifies the spoken utterance into one or more categories from a set of categories. For example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken. It will be understood that in the case of an audio processing task, the input to the neural network may comprise audio data (e.g. an audio signal), for example in the form of a sequence of audio data frames, and that the audio data may be processed to perform the audio processing task.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language to generate classification output that classifies the text into one or more categories from a set of categories.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

As another example, the task can be a computer vision task, where the input is an image or a point cloud and the output is a computer vision output for the image or point cloud. It will be understood that the image may comprise pixel data, which may be processed to perform the computer vision task.

For example, the computer vision task can be a classification task that requires generating a classification output. A classification output generally includes a respective score corresponding to each of multiple categories. The score for a category indicates a likelihood that the image belongs to the category. In some cases, the categories may be classes of objects (e.g., dog, cat, person, and the like), and the image may belong to a category if it depicts an object included in the object class corresponding to the category. In some cases, the categories may represent global image properties (e.g., whether the image depicts a scene in the day or at night, or whether the image depicts a scene in the summer or the winter), and the image may belong to the category if it has the global property corresponding to the category.

As another example, the computer vision task can be an object detection task. In an object detection task, the output generated by the neural network identifies locations, e.g., bounding boxes or other regions, in the input image at which particular types of objects are depicted.

As another example, the computer vision task can be an instance segmentation task. In an instance segmentation task, the output generated by the neural network identifies, for each pixel in the image that belongs to a particular object type, the object instance that the pixel corresponds to.

As another example, the computer vision task can be a semantic segmentation task. In a semantic segmentation task, the output generated by the neural network identifies, for each pixel in the image, which of multiple categories the pixel belongs to.

As another example, the computer vision task can be a depth prediction task. In a depth prediction task, the output generated by the neural network identifies, for each pixel in the image, a predicted depth of the scene at the pixel.

As another example, the computer vision task can be a surface normal prediction task. In a surface normal prediction task, the output generated by the neural network identifies, for each pixel in the image, a predicted surface normal of the scene at the pixel.

When the input is an image or point cloud, the neural network can include an embedding subnetwork that generates a respective embedding for each multiple patches of the image or point cloud, and the input to the first block of the neural network can be a sequence that includes the respective embeddings (and, optionally, one or more additional embeddings, e.g., at a predetermined position that will later be used to generate the output). Each patch includes the intensity values of the pixels in a different region of the input image.

In some implementations, the task is a multi-modal task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

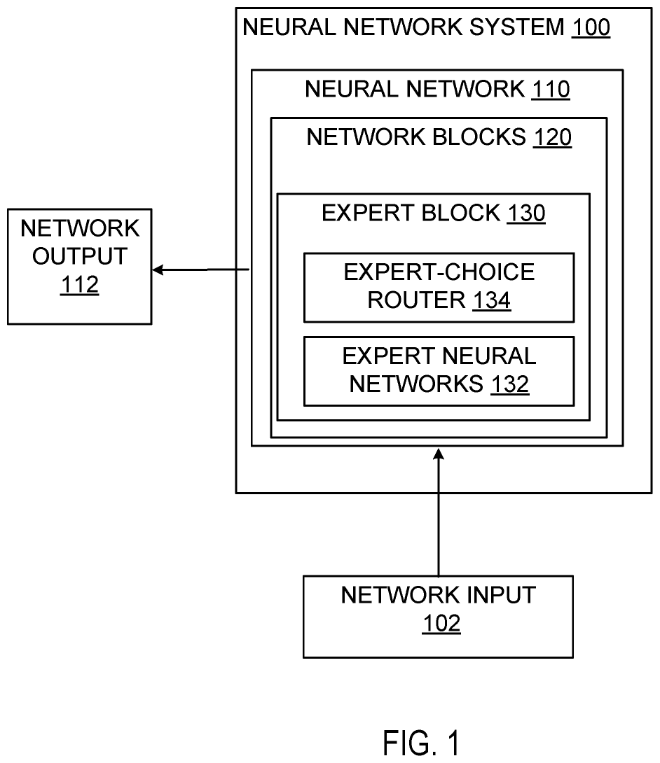

FIG. 1 shows an example neural network system 100. The neural network system 100 is an example of a system implemented as computer programs on one or more computers in one or more locations, in which the systems, components, and techniques described below can be implemented.

The system 100 is a system that processes a network input 102 using a neural network 110 to generate a network output 112 characterizing the network input 102 for a machine learning task, e.g., one of the tasks described above.

The neural network 110 includes a sequence of one or more network blocks 120 that are each configured to process a block input that includes the network input or an intermediate representation of the network input and to generate a block output.

A “network block,” as used in this specification, is a collection of one or more neural network layers that receive an input (“a block input”) and process the input to generate an output (a “block output”).

For example, the first network block in the sequence of network blocks 120 can process the network input 102 or embeddings of the network input generated by an embedding subnetwork to generate a block output that is an intermediate representation of the network input. Each subsequent network block 120 can then process the block output of the previous network block in the sequence.

In some implementations, the network output 112 for the neural network 110 is the block output of the final network block 120 in the sequence.

In some other implementations, the block output of the final network block 120 in the sequence is further processed using one or more output neural network layers to generate the network output 112 for the neural network 110.

The sequence of network blocks can include one or more “expert” network blocks 130. Each expert network block 130 includes multiple different expert subnetworks 132 that are each configured to process respective sub-inputs determined from the block input to the expert network block 132.

Each sub-input of the block input includes a respective different subset of the elements of the block input. In some implementations, each sub-input includes exactly one of the elements of the block input.

For each expert subnetwork 132 of the expert network block 130, an expert-choice router 134 within the expert network block 130 is configured to elect one or more of the sub-inputs to be processed by the expert subnetwork 132.

For example, the expert-choice router 134 can be configured to generate, for each expert subnetwork 132, a respective score for each sub-input, and then select, for processing by the expert subnetwork 132, the sub-inputs with the highest corresponding score.

More specifically, the router 134 implements “expert-choice” routing by independently selecting, for each subnetwork 132, which sub-inputs the expert subnetwork 132 will process. This is in contrast to “token-choice” or “sub-input” choice routing.

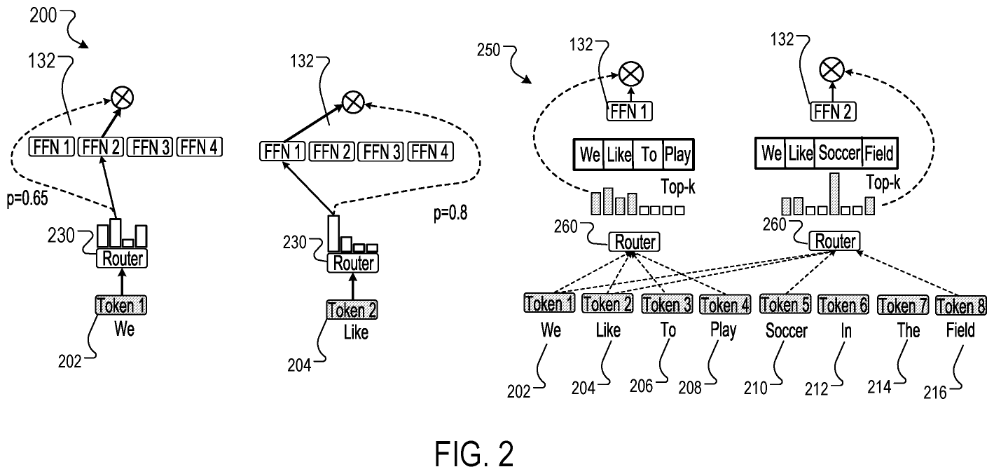

Expert-choice routing is described in more detail below with reference to FIG. 2.

Each of the expert subnetworks 132 can then process only the selected sub-input(s) for the subnetwork 132, generating a respective sub-output for each processed sub-input. The expert subnetwork 132 does not process any of the other sub-inputs that were not selected for the expert subnetwork. In other words, each expert subnetwork 132 is configured to process only a proper subset of the elements of the block input.

After each expert subnetwork 132 has executed, the expert network block 130 can determine a combined sub-output corresponding to each sub-input.

In particular, for each sub-input, the expert network block 130 can combine each sub-output that was generated by a respective expert subnetwork in response to processing the sub-input.

For sub-inputs that were not processed by any expert subnetwork 132, the combined sub-output of the sub-input can be the same as the sub-input.

The expert network block 130 can then combine the respective combined sub-outputs to generate the block output for the expert network block. For example, the expert network block 130 can concatenate the combined sub-outputs, e.g., in the same configuration (e.g., in the same order) as the corresponding sub-inputs in the block input.

The sub-inputs can be any appropriate subset of the elements of the block input. For example, if the neural network is configured to process an input sequence (e.g., an input sequence representing an image, text data, or audio data), then each block input can be an intermediate sequence that is an intermediate representation of the input sequence, and the sub-inputs can be subsequences of the intermediate sequence.

In some implementations, each sub-input is the same size, i.e., includes the same number of elements. For example, each sub-input can be a different one of the elements in the block input. In some other implementations, different sub-inputs can be different sizes, i.e., include different numbers of elements.

In some implementations, each element of the block input is in exactly one sub-input. In some other implementations, some or all of the elements of the block input can be in multiple different sub-inputs.

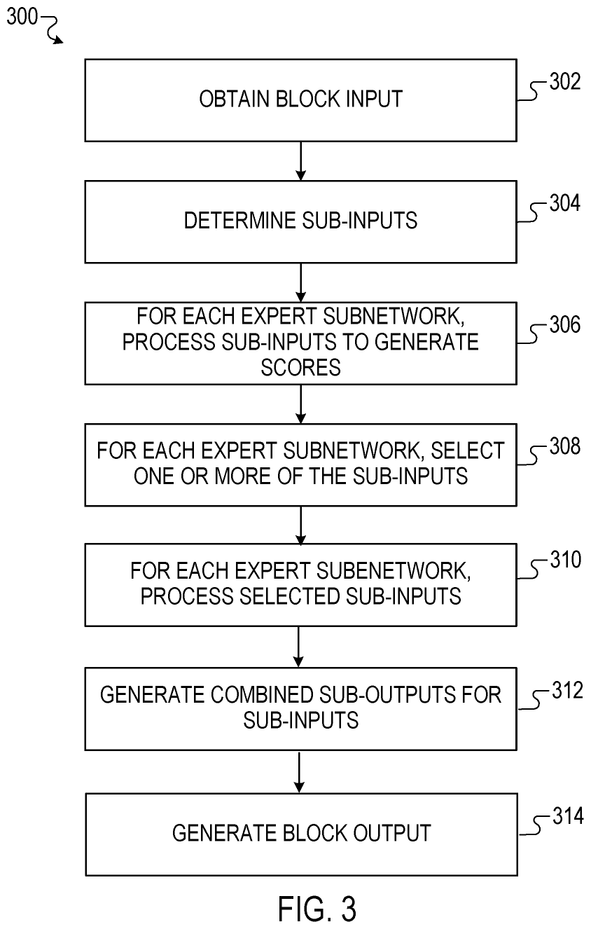

The operations performed by the expert network blocks 130 are described in more detail below with reference to FIGS. 2 and 3.

In some implementations, the sequence of network blocks 120 includes expert network blocks 130 interspersed among other types of network blocks, e.g., self-attention network blocks that apply self-attention, that do not include routers and expert neural networks, i.e., that do not perform conditional computation and use all of the parameters of network block for all inputs to the network block. As a particular example, the sequence of network blocks 120 can alternate between expert network blocks and self-attention network blocks. As another particular example, the sequence network blocks 120 can include self-attention network blocks, feed-forward network blocks that include a single neural network that has the same architecture as the expert neural networks 132 and that processes all of the sub-inputs in the block input to the feed-forward block, and expert network blocks 130. For example, every other self-attention network block in the sequence can be immediately followed by an expert network block 130, with the remainder of the self-attention network blocks being followed by a feed-forward network block.

Each self-attention network block is configured to process a block input using one or more self-attention neural network layers.

A self-attention neural network layer receives as input a sequence of input elements and applies an attention mechanism over the sequence of input elements to generate a sequence of layer outputs elements. In particular, for each input element, the self-attention neural network layer applies the attention mechanism over the sequence of input elements using one or more queries derived from the input element to generate a respective output element. Some self-attention neural network layers are multi-head self-attention neural network layers. A multi-head self-attention neural network layer applies h different attention mechanisms in parallel to generate respective sequences of output elements, and then combines the multiple sequences of output elements to generate a final sequence of output elements.

Self-attention is described in more detail below.

The expert network blocks 130 can each be implemented such that the expert subnetworks 132 of the expert network block 130 are executed in parallel for a given block input, thus improving the efficiency of the system. For example, the expert network block 130 can be implemented on a parallel processing device, e.g., a GPU or a TPU, that can execute the expert subnetworks on respective different threads. As another example, at least some expert subnetworks 132 of the expert network block 130 can be implemented on respective different devices, e.g., different devices that are communicatively connected and that provide the sub-outputs generated by the respective expert subnetwork to a single device for combining to generate the respective combined sub-outputs.

Thus, the network architecture of a neural network that includes expert network blocks 130 with multiple expert subnetworks 132 is optimized for efficient execution of the neural network. Such a network architecture allows the operations of the neural network to be parallelized for quick and low-cost execution, e.g., by parallelizing the operations of respective expert subnetworks across multiple devices. The neural network can thus be implemented on dedicated parallel processing hardware, e.g., a network of multiple parallel processing devices that each execute respective expert subnetworks of the neural network.

As will be described below, by implementing expert-choice routing, the system 100 optimizes the parallelization of the processing that is performed for each network input.

FIG. 2 shows the operations performed by a router of an expert network block 130 under token-choice routing 200 as employed by some conventional systems and under expert-choice routing 250 as described in this specification.

In particular, in the example of FIG. 2, the expert network block 130 is processing an intermediate representation of the sequence “We Like To Play Soccer In the Field,” such that the intermediate representation includes a respective element (“token”) 202-216 corresponding to each of the words in the sequence and the expert network block 130 includes four expert neural networks 132. In the example of FIG. 2, each expert 132 is a feedforward neural network (FFN). Additionally, in the example of FIG. 2, each sub-input includes a different one of the elements.

In token-choice routing 210, the expert block 130 processes each token 202-216 independently. As shown in FIG. 2, for token 1 202, a token-choice router 230 generates a respective score for each of the expert networks 132 and routes token 1 to “FFN 2” because FFN 2 has the highest score. For token 2 204, the token-choice router 230 generates a respective score for each of the expert networks 132 and routes token 2 to “FFN 1” because FFN 1 has the highest score.

Thus, when routing token 2, the token-choice router 230 does not take into account where token 1 was routed or, more generally, the score assigned to FFN 1 for any other tokens. As a result, this system can suffer from load imbalance, where some expert subnetworks process most or all of the elements of the block input while other expert subnetworks process very few or none of the elements of the block input. Such load imbalance can result in sub-optimal training because a portion of the network parameters (corresponding to the under-utilized expert subnetworks) do not receive meaningful updates during training and thus do not learn to extract useful information. Furthermore, this system dedicates the same amount of computational resources to each element of the network input, disregarding the relative importance of different elements, which can further reduce the computational efficiency of the systems.

In expert-choice routing 250, an expert-choice router 260 instead generates a respective score distribution for each expert neural network 132. The score distribution includes a respective score for each of the tokens 202-216. The expert-choice router 260 then selects, for each expert neural network 132 the top k scoring tokens according to the respective scores in the score distribution for the expert neural network 132.

For example, when k is equal to 4, the expert-choice router 260 can route the representations of tokens “We” “Like” “To” “Play” to FFN1 and the representations of tokens “We” “Like” “Soccer” “Field” to FFN2. Thus, the expert-choice router 260 can route the same token to multiple different expert neural networks 132 if a given token is in the top k of the score distributions for multiple different expert neural networks 132.

As can be seen from FIG. 2, expert-choice routing can ensure that the expert block is perfectly load balanced, e.g., by selecting the same number k of elements to be processed by each expert subnetwork. The computational and time efficiency of training the neural network can thus be significantly improved, as all parameters of the neural network receive meaningful updates for each network input. In some implementations, a neural network training system can reduce the time and computational resources required to achieve a predetermined performance using subnetwork-choice routing by more than 2× compared to token-choice routing. Furthermore, subnetwork-choice routing can allow a network block to more flexibly allocate computational resources to respective elements, e.g., by routing relatively important elements to more expert subnetworks than relatively unimportant elements.

Processing input using expert choice routing is described in more detail below with reference to FIG. 3.

FIG. 3 is a flow diagram 300 of an example process for processing a block input using an expert block. For convenience, the process 300 will be described as being performed by a system of one or more computers located in one or more locations. For example, an expert block included in a neural network system, e.g., one of the expert blocks 130 included in the neural network system 100 of FIG. 1, appropriately programmed, can perform the process 200.

The expert block obtains a block input that represents an intermediate representation of the network input (step 302).

The expert block determines a plurality of sub-inputs from the block input (step 304). Each sub-input includes a respective different subset of the plurality of elements of the block input. In some implementations, each sub-input includes exactly one of the elements of the block input, i.e., each sub-input is a different one of the elements of the block input.

More generally, in some implementations, each sub-input is the same size, i.e., includes the same number of elements. In some other implementations, different sub-inputs can be different sizes, i.e., include different numbers of elements.

In some implementations, each element of the block input is in exactly one sub-input. In some other implementations, some or all of the elements of the block input can be in multiple different sub-inputs.

The expert block then performs steps 306-310 for each of a plurality of expert subnetworks of the expert network block.

The expert block processes the plurality of sub-inputs to generate a respective score for each sub-input (step 306).

For each expert subnetwork, the expert network block, i.e., the expert-choice router within the block, can determine the scores for the sub-inputs in any appropriate way. For example, for each expert subnetwork, the expert network block can process each sub-input using one or more neural network layers, e.g., one or more feedforward neural network layers, to generate a respective score. As a particular example, the expert network block can compute:

S=Softmax(X·W_{g})

where X∈ [symbol] ^{l×d} is a matrix that includes a respective row corresponding to each sub-input, l is a number of sub-inputs in the block input, d is a dimensionality of each sub-input, W_{g}∈ [symbol] ^{d×e} is a matrix of the expert network block that includes a respective column corresponding to each expert subnetwork, and e is a number of expert subnetworks in the expert network block.

As another example, for each expert subnetwork, the expert network block can process each sub-input using one or more convolutional neural network layers and/or one or more self-attention layers to generate the respective scores. Self-attention is discussed in more detail below.

The system selects one or more of the sub-inputs according to the respective scores (step 308).

For each expert subnetwork, after the expert network block generates a respective score for each sub-input, the expert network block, i.e., the expert-choice router within the block, can select the sub-inputs with the k highest scores for the expert subnetwork to process. For example, the expert network block can compute:

G,I=TopK(S^{T},k)

P=Onehot(I)

where TopK(S^{T},k) selects the k largest entries for each row of S^{T}, I∈ [symbol] ^{e×k} is a matrix whose (i,j)^{th} element identifies the sub-input that has the j^{th}-largest score for the i^{th} expert subnetwork, and G∈ [symbol] ^{e×k} is a matrix whose (i,j)^{th} element represents the score of the sub-input that has the j^{th}-largest score for the i^{th} expert subnetwork, and P∈ [symbol] ^{e×k×l} is a one-hot matrix whose (i,j,m)^{th} element is equal to one if the m^{th} sub-input has the j^{th}-largest score for the i^{th} expert subnetwork and zero otherwise.

In some implementations, the expert network block can enforce that each sub-input is selected by at most b different expert subnetworks. For example, the expert network block can solve the following entropy-regularized linear programming problem:

$${max}_{A} 〈 {S}^{⊤} , A 〉 + λ H ( A ) \\ s . t . ∀ i : {\sum }_{{j}^{′}} A [ i , {j}^{′} ] = k \\ ∀ j : {\sum }_{{i}^{′}} A [ {i}^{′} , j ] \leq b \\ ∀ i , j : 0 \leq A [ i , j ] \leq 1$$

where (x,y) represents the inner product between x and y, H(A), is the sum of element-wise entropy, λ is a constant value, and b>0 is an integer that upper bounds the selection for each token. That is, H(A)=Σᵢⱼ−A[i,j]log A[i,j].

Adding a small entropy term, i.e., (λH(A)), can give a near-integer solution while allowing the expert network block to be executed more efficiently by a parallel processing device, e.g., by a graphics processing unit (GPU) or a tensor processing unit (TPU), when enforcing the upper bound during processing. Deploying the neural network on one or more parallel processing hardware is discussed in more detail below.

As a particular example, the expert network block can solve the above problem using Dykstra's algorithm.

After computing the matrix A, the network block can generate the matrices I and G by determining G, I=TopK(A,k) as described above.

Optionally, during training, for each expert subnetwork, the expert network block randomly samples a noise value for each sub-input and adds the noise value to the corresponding score before determining the k highest scores for the expert subnetwork. Instead or in addition, the expert network block can apply a nonlinear activation function, e.g., a softmax, Tanh, or ReLU function, to the scores before determining the k highest scores. Performing either or both of these operations can assist in exploration during training.

In some implementations, each expert subnetwork selects the same number of sub-inputs. That is, each expert subnetwork can select the k sub-inputs that have the highest corresponding scores, where k is the same for all expert subnetworks. As a particular example, the same k of sub-inputs processed by each expert subnetwork can be equal to:

$$k = \frac{l \cdot c}{e}$$

where l is the number of sub-inputs in the block input, e is the number of expert subnetworks in the expert network block, and c is a hyperparameter of the expert network block representing an average number of sub-inputs to be processed per expert subnetwork of the expert network block.

In some other implementations, some expert subnetworks select a different number of sub-inputs. For example, an expert subnetwork can select a sub-input if the score for the sub-input satisfies a threshold.

For each selected sub-input, the expert block processes the selected sub-input using the expert subnetwork to generate a respective sub-output (step 310).

In other words, after selecting k sub-inputs, each expert subnetwork can process the k sub-inputs using one or more neural network layers to generate a respective sub-output. For example, each expert subnetwork can include one or more feedforward neural network layers, one or more convolutional neural network layers, one or more recurrent neural network layers, and/or one or more self-attention neural network layers.

As a particular example, each expert subnetwork i can generate a respective sub-output for each sub-input by computing:

Xᵢₙ=P·X

$${X}_{e} [ i ] = ACT ( {X}_{in} [ i ] \cdot {W}_{1} [ i ] ) \cdot {{W}_{2} [ i ]}^{⊤}$$

where Xᵢₙ[i]∈ [symbol] ^{k×d} is an input to the i^{th} expert subnetwork, W₁[i] and W₂[i] are weight matrices of the i^{th} expert subnetwork, ACT is an activation function, and Xₑ[i]∈ [symbol] ^{k×d} is a matrix whose j^{th} row represents the sub-output for the j^{th} sub-input processed by the expert subnetwork i. For instance, the expert subnetwork can use a Gaussian-error Linear Unit (GeLU) as the activation function. In some implementations, the expert subnetwork i can add one or more bias terms to the determined Xₑ[i].

Once the expert subnetworks have completed processing, for each of the plurality of sub-inputs, the system processes the sub-outputs corresponding to the sub-input generated by respective expert subnetworks to generate a combined sub-output for the sub-input (step 312). In particular, for each sub-input, the expert network block can combine each sub-output that was generated by a respective expert subnetwork in response to processing the sub-input. For any sub-inputs that were not processed by any expert subnetwork, the combined sub-output of the sub-input can be the same as the sub-input.

In some implementations, the expert network block can generate the combined sub-output by computing a sum of the sub-outputs. For example, the expert network block can compute a weighted sum of the sub-outputs, where each sub-output is weighted by the score of the corresponding sub-input for the expert subnetwork that generated the sub-output.

In particular, the expert network block can compute:

$${X}_{out} [ m , n ] = {\sum }_{i , j} P [ i , j , m ] \cdot G [ i , j ] \cdot {X}_{e} [ i , j , n ]$$

where Xₒᵤₜ∈ [symbol] ^{l×d} is a matrix whose m^{th} row represents the combined sub-output for the m^{th} sub-input.

In some other implementations, the expert network block combines the sub-outputs for each sub-input by processing the sub-outputs using one or more neural network layers, e.g., one or more self-attention layers, one or more convolutional neural network layers, and/or one or more recurrent neural network layers.

The system generates a block output by combining the respective combined sub-outputs for the plurality of sub-inputs (step 314). For example, the expert network block can concatenate the combined sub-outputs, e.g., in the same configuration (e.g., in the same order) as the corresponding sub-inputs in the block input.

Optionally, as part of combining the sub-outputs, the system can apply one or more additional operations to the concatenation of the combined sub-outputs, e.g., the concatenation may be processed by one or more of feed-forward layers, skip connections, or normalization operations, e.g., layer normalization, to provide the block output.

The expert network block can be implemented such that the expert subnetworks of the expert network block are executed in parallel for a given block input, thus improving the efficiency of the system. For example, the expert network block can be implemented on a parallel processing device, e.g., a GPU or a TPU, that can execute the expert subnetworks on respective different threads. As another example, at least some expert subnetworks of the expert network block can be implemented on respective different devices, e.g., different devices that are communicatively connected and that provide the sub-outputs generated by the respective expert subnetwork to a single device for combining to generate the respective combined sub-outputs.

Thus, the network architecture of a neural network that includes expert network blocks with multiple expert subnetworks is optimized for efficient execution of the neural network. Such a network architecture allows the operations of the neural network to be parallelized for quick and low-cost execution, e.g., by parallelizing the operations of respective expert subnetworks across multiple devices. The neural network can thus be implemented on dedicated parallel processing hardware, e.g., a network of multiple parallel processing devices that each execute respective expert subnetworks of the neural network.

In some implementations, before assigning sub-inputs of the block input to respective expert subnetworks, the expert network block first processes the block input using one or more neural network layers to generate an updated representation of the block input, then assigns sub-inputs of the updated representation of the block input to respective expert subnetworks. That is, the input to the expert subnetworks can be a strict subset of the elements of an updated representation of the block input, rather than the block input itself. Generally, this specification refers to sub-inputs of a block input, but it is to be understood that the same techniques can be applied to sub-inputs of an updated representation of the block input. Equivalently, these neural network layers that precede the expert subnetworks can be considered part of the previous network block in the sequence of network blocks.

Prior to using the neural network to perform the machine learning task, a training system trains the neural network to perform the task, i.e., to determine trained values of the parameters of the neural network, i.e., of the blocks in the sequence, and, optionally, an embedding subnetwork used to generate the input to the first block in the sequence, an output subnetwork that generates the network output from the output of the last block in the sequence, or both. For example, the training system can train the neural network from scratch on training data for the task to minimize a loss function for the task, e.g., a cross-entropy loss, a negative log likelihood loss, and so on using conventional machine learning techniques. As another example, the training system can first pre-train the neural network on an unsupervised objective and then fine-tune the neural network on the training data for the task. As yet another example, the training system can train the neural network on both unlabeled data and the training data for the task through semi-supervised learning.

Because the system employs expert-choice routing in which load balancing can be “baked-in,” the system does not need to utilize any auxiliary losses that encourage load balancing across experts during training, improving the stability and efficiency of training relative to conventional approaches.

Moreover, by making use of expert-choice routing and training the router of each expert block by backpropagating gradients of the overall loss, the system allows each expert subnetwork to be trained, i.e., to become configured through training, to process different types of network inputs, allowing the expert subnetworks to “specialize” and further improving the efficiency and performance of the neural network.

During training, the training system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the neural network in parallel. Moreover, as described above, the system can first pre-train the neural network on a large unsupervised data set through unsupervised learning, e.g., to minimize a BERT loss or other unsupervised loss, and then fine-tune the neural network on task-specific training data to optimize the loss function for the task.

An “embedding,” as used in this specification is a vector of numeric values, e.g., floating point or other type of numeric values, that has a predetermined dimensionality, e.g., has a predetermined number of values.

A self-attention block, as referred to above, is a neural network layer that includes an attention mechanism that operates over the self-attention block input (or an input derived from the layer input) to generate the self-attention block output. A self-attention mechanism may be causally masked so that any given position in an input sequence does not attend over (e.g. use data from) any positions after the given position in the input sequence. There are many different possible attention mechanisms. Some examples of self-attention layers including attention mechanisms, are described in Vaswani et al. “Attention is all you need”, 31st Conference on Neural Information Processing Systems (NIPS 2017), Long Beach, CA, USA; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, an attention mechanism maps a query and a set of key-value pairs to an output, where the query, keys, and values are all vectors. The output is computed as a weighted sum of the values, where the weight assigned to each value is computed by a compatibility function, e.g. a dot product or scaled dot product, of the query with the corresponding key.

Generally, a self-attention mechanism is configured to relate different positions in the same sequence to determine a transformed version of the sequence as an output. For example the attention layer input may comprise a vector for each element of the input sequence. These vectors provide an input to the self-attention mechanism and are used by the self-attention mechanism to determine a new representation of the same sequence for the attention layer output, which similarly comprises a vector for each element of the input sequence. An output of the self-attention mechanism may be used as the attention layer output, or it may be processed by one or more of feed-forward layers, skip connections, or normalization operations to provide the attention layer output.

In some implementations the attention mechanism is configured to apply each of a query transformation e.g. defined by a matrix W^{Q}, a key transformation e.g. defined by a matrix W^{K}, and a value transformation e.g. defined by a matrix W^{V}, to the attention layer input which is the input data X to the attention layer, to derive a query matrix Q=XW^{Q} that includes a respective query for each vector in the input sequence, key matrix K=XW^{K} that includes a respective key for each vector in the input sequence, and value matrix V=XW^{V} that includes a respective value for each vector in the input sequence, which are used determine an attended sequence for the output. For example the attention mechanism may be a dot product attention mechanism applied by applying each query vector to each key vector to determine respective weights for each value vector, then combining the value vectors using the respective weights to determine the self-attention layer output for each element of the input sequence. The self-attention layer output may be scaled by a scaling factor e.g. by the square root of the dimensions of the queries and keys, to implement scaled dot product attention. Thus, for example, an output of the attention mechanism may be determined as softmax

$$( \frac{{QK}^{T}}{\sqrt{d}} )$$

V where d is a dimension of the key (and value) vector. In another implementation the attention mechanism be comprise an “additive attention” mechanism that computes the compatibility function using a feed-forward network with a hidden layer. The output of the attention mechanism may be further processed by one or more fully-connected, feed forward neural network layers.

The attention mechanism may implement multi-head attention, that is, it may apply multiple different attention mechanisms in parallel. The outputs of these may then be combined, e.g. concatenated, with a learned linear transformation applied to reduce to the original dimensionality if necessary.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. 10

What is claimed is:

1. A system comprising one or more computers and one or more storage devices storing instructions that when executed by the one or more computers cause the one or more computers to implement a neural network that is configured to process a network input and to generate a network output for the network input, the neural network comprising a sequence of one or more network blocks, the sequence comprising one or more expert network blocks configured to perform operations comprising:
obtaining a block input that represents an intermediate representation of the network input, the block input comprising a plurality of elements;
determining a plurality of sub-inputs from the block input, each sub-input comprising a respective different subset of the plurality of elements of the block input;
for each of a plurality of expert subnetworks of the expert network block:
processing the plurality of sub-inputs to generate a respective score for each sub-input;
selecting one or more of the sub-inputs according to the respective scores; and
for each selected sub-input, processing the selected sub-input using the expert subnetwork to generate a respective sub-output;
for each of the plurality of sub-inputs, processing the sub-outputs corresponding to the sub-input generated by respective expert subnetworks to generate a combined sub-output for the sub-input; and
generating a block output by combining the respective combined sub-outputs for the plurality of sub-inputs.

2. The system of claim 1, wherein each expert subnetwork is configured to process a same number of sub-inputs.

3. The system of claim 2, wherein the same number k of sub-inputs processed by each expert subnetwork is equal to:
$$k = \frac{l \cdot c}{e}$$
wherein I is a number of sub-inputs in the block input, e is a number of expert subnetworks in the expert network block, and c is a hyperparameter of the neural network representing an average number of sub-inputs to be processed per expert subnetwork.

4. The system of claim 1, wherein, for each expert subnetwork, processing the plurality of sub-inputs to generate a respective score for each sub-input comprises computing:
S=Softmax(X·W_{g})
wherein X∈ [symbol] ^{l×d} is a matrix that includes a respective row corresponding to each sub-input, l is a number of sub-inputs in the block input, d is a dimensionality of each sub-input, W_{g}∈ [symbol] ^{d×s} is a matrix that includes a respective column corresponding to each expert subnetwork, and e is a number of expert subnetworks in the expert network block.

5. The system of claim 4, wherein, for each expert subnetwork, selecting one or more of the sub-inputs according to the respective scores comprises computing:
G,I=TopK(S^{T},k)
P=Onehot(I)
wherein k is a number of sub-inputs selected by each expert subnetwork, I∈ [symbol] ^{e×k} is a matrix whose (i,j)^{th} element identifies the sub-input that has the f^{th}-largest score for the i^{th} expert subnetwork, and G∈ [symbol] ^{e×k} is a matrix whose (i,j)^{th} element represents the score of the sub-input that has the j^{th}-largest score for the i^{th} expert subnetwork, and P∈ [symbol] ^{e×k×l} is a one-hot matrix whose (i,f,m)^{th} element is equal to one if the m^{th} sub-input has the j^{th}-largest score for the i^{th} expert subnetwork and zero otherwise.

6. The system of claim 1, wherein each sub-input is processed by at most a threshold number b different expert subnetworks.

7. The system of claim 6, wherein for each expert subnetwork, selecting one or more of the sub-inputs according to the respective scores comprises:
computing:
$${max}_{A} 〈 {S}^{⊤} , A 〉 + λ H ( A ) \\ s . t . ∀ i : {\sum }_{{j}^{′}} A [ i , {j}^{′} ] = k \\ ∀ j : {\sum }_{{i}^{′}} A [ {i}^{′} , j ] \leq b \\ ∀ i , j : 0 \leq A [ i , j ] \leq 1$$
wherein (S^{T},A) represents an inner product between S^{T} and A, and
wherein H(A)=Σᵢⱼ−A[i,j] log A [i,j]; and
computing:
G,I=TopK(A,k)
P=Onehot(I)
wherein k is a number of sub-inputs selected by each expert subnetwork, J∈ [symbol] ^{e×k} is a matrix whose (i,j)^{th} element identifies the sub-input that has the j^{th}-largest score for the i^{th} expert subnetwork, and G∈ [symbol] ^{e×k} is a matrix whose (i,j)^{th} element represents the score of the sub-input that has the j^{th}-largest score for the i^{th} expert subnetwork, and P∈ [symbol] ^{e×k×l} is a one-hot matrix whose (i,j,m)^{th} element is equal to one if the m^{th} sub-input has the j^{th}-largest score for the i^{th} expert subnetwork and zero otherwise.

8. The system of claim 5, wherein for each expert subnetwork i, processing each selected sub-input using the expert subnetwork to generate a respective sub-output comprises computing:
Xᵢₙ=P·X
$${X}_{e} [ i ] = ACT ( {X}_{in} [ i ] \cdot {W}_{1} [ i ] ) \cdot {{W}_{2} [ i ]}^{⊤}$$
wherein Xᵢₙ[f]∈ [symbol] ^{k×d} is an input to the i^{th} expert subnetwork, W₁[i] and W₂[i] are weight matrices of the i^{th} expert subnetwork, ACT is an activation function, and Xₑ[i]∈ [symbol] ^{k×d} is a matrix whose j^{th} row represents the sub-output for the j^{th} sub-input processed by the expert subnetwork i.

9. The system of claim 8, wherein for each expert subnetwork i, processing each selected sub-input using the expert subnetwork to generate a respective sub-output further comprises adding one or more bias terms to Xₑ[i].

10. The system of claim 8, wherein, for each of the plurality of sub-inputs, processing the sub-outputs corresponding to the sub-input generated by respective expert subnetworks to generate a combined sub-output for the sub-input comprises computing:
$${X}_{out} [ m , n ] = {\sum }_{i , j} P [ i , j , m ] \cdot G [ i , j ] \cdot {X}_{e} [ i , j , n ]$$
wherein Xₒᵤₜ∈ [symbol] ^{l×d} is a matrix whose m^{th} row represents the combined sub-output for the m^{th} sub-input.

11. The system of claim 1, wherein, for each of the plurality of sub-inputs, processing the sub-outputs corresponding to the sub-input generated by respective expert subnetworks to generate a combined sub-output for the sub-input comprises:
determining a weighted sum of the sub-outputs corresponding to the sub-input, wherein each sub-output is weighted by the score of the sub-input for the expert subnetwork that generated the sub-output.

12. The system of claim 1, wherein the operations of at least some of the plurality of expert subnetworks are executed in parallel.

13. The system of claim 1, wherein the operations of at least some of the plurality of expert subnetworks are executed by respective different devices.

14. A method performed by one or more computers, the method comprising:
receiving a network input; and
processing the network input using a neural network to generate a network output for the network input, the neural network comprising a sequence of one or more network blocks, the sequence comprising one or more expert network blocks that are each configured to perform operations comprising:
obtaining a block input that represents an intermediate representation of the network input, the block input comprising a plurality of elements;
determining a plurality of sub-inputs from the block input, each sub-input comprising a respective different subset of the plurality of elements of the block input;
for each of a plurality of expert subnetworks of the expert network block:
processing the plurality of sub-inputs to generate a respective score for each sub-input;
selecting one or more of the sub-inputs according to the respective scores; and
for each selected sub-input, processing the selected sub-input using the expert subnetwork to generate a respective sub-output;
for each of the plurality of sub-inputs, processing the sub-outputs corresponding to the sub-input generated by respective expert subnetworks to generate a combined sub-output for the sub-input; and
generating a block output by combining the respective combined sub-outputs for the plurality of sub-inputs.

15. One or more non-transitory computer storage media storing instructions that when executed by one or more computers cause the one more computers to implement a neural network that is configured to process a network input and to generate a network output for the network input, the neural network comprising a sequence of one or more network blocks, the sequence comprising one or more expert network blocks configured to perform operations comprising:
obtaining a block input that represents an intermediate representation of the network input, the block input comprising a plurality of elements;
determining a plurality of sub-inputs from the block input, each sub-input comprising a respective different subset of the plurality of elements of the block input;
for each of a plurality of expert subnetworks of the expert network block:
processing the plurality of sub-inputs to generate a respective score for each sub-input;
selecting one or more of the sub-inputs according to the respective scores; and
for each selected sub-input, processing the selected sub-input using the expert subnetwork to generate a respective sub-output;
for each of the plurality of sub-inputs, processing the sub-outputs corresponding to the sub-input generated by respective expert subnetworks to generate a combined sub-output for the sub-input; and
generating a block output by combining the respective combined sub-outputs for the plurality of sub-inputs.

16. The method of claim 14, wherein each expert subnetwork is configured to process a same number of sub-inputs.

17. The method of claim 16, wherein the same number k of sub-inputs processed by each expert subnetwork is equal to:
$$k = \frac{l \cdot c}{e}$$
wherein l is a number of sub-inputs in the block input, e is a number of expert subnetworks in the expert network block, and c is a hyperparameter of the neural network representing an average number of sub-inputs to be processed per expert subnetwork.

18. The method of claim 14, wherein, for each expert subnetwork, processing the plurality of sub-inputs to generate a respective score for each sub-input comprises computing:
S=Softmax(X·W_{g})
wherein X∈ [symbol] ^{l×d} is a matrix that includes a respective row corresponding to each sub-input, l is a number of sub-inputs in the block input, d is a dimensionality of each sub-input, W_{g}∈ [symbol] ^{d×e} is a matrix that includes a respective column corresponding to each expert subnetwork, and e is a number of expert subnetworks in the expert network block.

19. The method of claim 18, wherein, for each expert subnetwork, selecting one or more of the sub-inputs according to the respective scores comprises computing:
G,I=TopK(S^{T},k)
P=Onehot(I)
wherein k is a number of sub-inputs selected by each expert subnetwork, l∈ [symbol] ^{e×k} is a matrix whose (i,j)^{th} element identifies the sub-input that has the j^{th}-largest score for the i^{th} expert subnetwork, and G∈ [symbol] ^{e×k} is a matrix whose (i,j)^{th} element represents the score of the sub-input that has the j^{th}-largest score for the i^{th} expert subnetwork, and P∈ [symbol] ^{e×k×l} is a one-hot matrix whose (i,j,m)^{th} element is equal to one if the m^{th} sub-input has the j^{th}-largest score for the i^{th} expert subnetwork and zero otherwise.

20. The method of claim 14, wherein each sub-input is processed by at most a threshold number b different expert subnetworks.
